(19) United States
(12) Patent Application Publication
(10) Pub. No.: US 2003/0033442 A1
(43) Pub. Date: Feb. 13, 2003

(54) Apparatus and method for providing a class versioning architecture

(76) Inventors: Joel Halpern, Leesburg, VA (US); James L. Logan III, Herndon, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/196,573

(22) Filed: Jul. 16, 2002

Related U.S. Application Data
(60) Provisional application No. 60/307,041, filed on Jul. 16, 2001.
(60) Provisional application No. 60/305,647, filed on Jul. 16, 2001.

(51) Int. Cl. G06F 9/44

(52) U.S. Cl. 709/315; 717/170

(57) ABSTRACT

The present invention generally relates to object-oriented programming and more specifically relates to creating an environment where an application server may continue running while its owner makes various kinds of changes to it by employing a versioning architecture for managing version changes for classes in object-oriented environments. In a first embodiment, the system uses an explicit versioning scheme, whereas a second embodiment employs implicit versioning. In both systems, subsequent versions are created, compiled and deployed “on-the-fly” such that subsequent versions of the object class inherit all attributes, associations and operations from prior versions of the object, and wherein all versions of the object class are deployed by mapping each class into a persistence storage means.

### RELATED APPLICATIONS

This application claims the benefit of U.S. Provisional Application Serial Nos.: 60/307,041 and 60/305,647, both filed Jul. 16, 2001, and incorporated herein by reference for all purposes

### FIELD OF THE INVENTION

The present invention generally relates to object-oriented programming and more specifically relates to creating an environment where an application server may continue running while its owner makes various kinds of changes to it by employing a versioning architecture for managing version changes for classes in object-oriented environments.

### BACKGROUND INFORMATION

The Internet is operated by Internet Service Providers (ISPs). These ISP's provide access to literally millions upon millions of users who rely upon ISPs to provide rapid access to the many web sites that are available. The ISPs in turn rely upon the millions of users for income for access as well as income derived from advertising and other services. Thus the ISPs have a vested interest in keeping its users happy.

ISPs invest million of dollars in improvements to their networks and operating systems as well as hardware and associated software. There are times when new software must be employed in order to keep the operations of the ISP at a level that is acceptable to the many ISP customers. However, upgrading software can be fraught with dangers such as downtime of the ISP, incompatibility issues with existing systems and other operational issues relating to the upgrade.

Computer systems generally, and those specifically used by ISP's and others, typically include a combination of hardware (e.g., semiconductors, circuit boards, etc.) and software (e.g., computer programs). As advances in semiconductor processing and computer architecture push the performance of the computer hardware higher, more sophisticated computer software has evolved to take advantage of the higher performance of the hardware, resulting in computer systems today that are much more powerful than just a few years ago.

Computer systems typically include operating system software that controls the basic function of the computer, and one or more software application programs that run under the control of the operating system to perform desired tasks. For example, a typical server may have the following configuration:

Dell 6450 w/4 Intel 700 MHz Xeon Processors

36 GB Ultra 3 SCSI Hard disk

4 GB SDRAM

2 Intel Pro 1000 Gigabit Network Interface Cards

and run any variety of Windows, Unix, or other operating systems and applications software. However, this is not a static picture. As the capabilities of computer systems have increased, the application software programs designed for high performance computer systems have become extremely powerful. Additionally, software development costs have continued to rise because more powerful and complex programs take more time, and hence more money, to produce.

One way in which the performance of application software programs has been improved while the associated development costs have been reduced is by using object-oriented programming concepts. The goal of using object-oriented programming is to create small, reusable sections of program code known as “objects” that can be quickly and easily combined and re-used to create new programs. This is similar to the idea of using the same set of building blocks again and again to create many different structures. The modular and re-usable aspects of objects will typically speed development of new programs, thereby reducing the costs associated with the development cycle. In addition, by creating and re-using a comprehensive set of well-tested objects, a more stable, uniform, and consistent approach to developing new computer programs can be achieved.

Object-oriented programming is a method of program implementation in which programs are organized as cooperative collections of objects, each of which represents an instance of some class, and whose classes are all members of a hierarchy of classes united via inheritance relationships. Object-oriented programming differs from standard procedural programming in that it uses objects, not algorithms, as the fundamental building blocks for creating computer programs. This difference stems from the fact that the design focus of object-oriented programming technology is wholly different than that of procedural programming technology.

The focus of procedural-based design is on the overall process used to solve the problem; whereas the focus of object-oriented design is on casting the problem as a set of autonomous entities that can work together to provide a solution. The autonomous entities of object-oriented technology are, of course, objects. Object-oriented technology is significantly different from procedural technology because problems are broken down into sets of cooperating objects instead of into hierarchies of nested computer programs or procedures.

Thus, a pure object-oriented program is made up of code entities called objects. Each object is an identifiable, encapsulated piece of code and data that provides one or more services when requested by a client. Conceptually, an object has two parts, an external object interface and internal object implementation. In particular, all object implementation functions are encapsulated by the object interface such that other objects must communicate with that object through its object interface. The only way to retrieve, process or otherwise operate on the object is through the methods and attributes exposed as the defined interface to the object. This protects the internal data portion of the object from outside tampering. Additionally, because outside objects have no access to the internal implementation, that internal implementation can change without affecting other aspects of the program.

In this way, the object system isolates the requester of services (client objects) from the providers of services (server objects) by a well defined encapsulating interface. In the classic object model, a client object sends request messages to server objects to perform any necessary or desired function. The message identifies a specific method to be performed by the server object, and also supplies any required parameters. The server object receives and interprets the message, and can then decide what service to perform.

There are many computer languages available today that support object-oriented programming. For example, Smalitalk, Object Pascal, C++ and JAVA are all examples of languages that support object-oriented programming to one degree or another.

A central concept in object-oriented programming is the “class.” A class is a template or prototype that defines a type of object. A class outlines or describes the characteristics or makeup of objects that belong to that class. By defining a class, objects can be created that belong to the class without having to rewrite the entire definition for each new object as it is created. This feature of object-oriented programming promotes the reusability of existing object definitions and promotes more efficient use of code.

Computer programs naturally evolve over time. The evolution of object-oriented computer programs entails defining new classes that have implementations different than previous versions. As time passes, the type and quantity of information stored by these objects may need to be changed or enhanced to accommodate additional or different data types. In this case, the definition of the class will, of necessity, be changed to support the new object data storage requirements. This scenario typically occurs when a program is upgraded from a first software version to a newer, more powerful version of the program. A new release of an existing program may use a combination of new classes and classes that were defined in a previous version. The processes and activities-associated with modifying, updating, and tracking changes in a class over a period of time are known as “versioning.”

It is important to note that, even though a program has been upgraded, it is frequently necessary to maintain both the existing objects that were created by the first version (belonging to one version of a class) and the new objects that are created by the newer version of the software application (belonging to a different version of the same class). In order to accomplish this, some mechanism should be provided to track the various names of the object classes as the versions of the software application are changed. Theoretically, it is possible to give each new class version the same name. However, in practice, many object-oriented programming languages, such as JAVA, require that each co-existing version of the class have a different name. This means that as time passes and multiple versions of the various classes are changed yet remain available for use, it can become very difficult to keep track of the many different names for each class and the related objects that are created.

For example, a large company that has been in business for many years may have changed the nature of the object used to store employee-related data as the information needs of the business developed. Beginning in 1970, the employee object tracked the name, address, phone number, date of hire, supervisor, and salary for each employee. In 1980 the definition of the objects in the employee class was changed to include information regarding 401K plans for the employee and in 1990 the definition for the employee class was changed again to include information regarding each employee's performance and evaluation reviews.

There are several solutions that have been previously implemented to address the versioning problems associated with multiple names for different versions of the same class. Typically, when a new version of a software application is to be implemented, the software application is recompiled and the system must be shut down. When the new version of the software application is loaded, the system will recognize that a new version has been created, load all the existing objects, and rebuild the objects one by one so that they are compatible with the new version of the software application. This process may also include a re-naming of all existing objects. While this solution is acceptable for systems with a limited number of objects, once the number of objects in the system exceeds a certain minimal level, the operational overhead associated with rebuilding each object in the system every time the version changes can quickly become unacceptable. This is especially true for systems that need to be operational “24/7/365,” such as for Internet service providers (ISPs), that cannot be “off-line” for recompiling, and therefore must usually provide redundant systems.

One typical solution for upgrading software applications has been to upgrade everything at once and provide dual mode operations until there were no applications that needed to use the old software. This “solution,” however, would be quite burdensome for large-scale ISPs. For example, a large ISP will have many pieces of hardware, operating system software and application software that is required to run the network. If the ISP has been in business a number of years, the objects and classes of objects may have changed as the information needs and operational needs of the ISP have developed. At its inception, the ISP may have tracked its subscriber information only. However as time progressed, this tracking of information has evolved in demographic information about users as well as the likes and dislikes, and surfing habits of the ISPs subscribers. This information requires different type of storage objects and application program from the early period of the existence of the ISP to the present day.

Another possible solution has been to create a sub-class for the new version of the objects as they are needed. This solution, while useful, has its own inherent limitations. Specifically, as each new version of the class is created, another level in the class hierarchy is established. After a period of time, tracking class versions through the nested hierarchy of classes and sub-classes becomes extremely inefficient and can measurably reduce system performance.

Without a mechanism for more easily and flexibly creating, managing, and tracking the various versions of object classes that must be utilized in a large-scale, frequently evolving object-oriented environment, the computer industry will continue to suffer from the effects of the inefficient versioning methods presently used to manage new class versions. In addition, the creation of objects according to the desired class version will continue to be more difficult and uncertain than necessary.

Others have attempted to address some of these same versioning issues. U.S. Pat. No. 5,974,428 discloses a class versioning and mapping system that allows a user to request a desired class without knowing which class version is the most recent or correct version for the desired class. This class versioning and mapping system uses a version mapping mechanism to cross reference the requested class, select the most recent or best version of the requested class, and then return an object to the user that belongs to the selected class.

U.S. Pat. No. 6,119,130 discloses a method and apparatus that allow schema version evolution to occur without requiring applications that expect older schema versions to be recompiled is provided. According to one aspect of the patent, each application that requests data is supplied the data in the format that the application expects. To supply the data in the expected format, a mechanism is provided for tracking the evolution of data types without losing information. In addition, mechanisms are provided for determining the format expected by the application and the format in which the data is currently stored. A mechanism is also provided for converting the data from the stored format to the expected format when the two formats do not match. A data migration strategy is described in which data is gradually migrated to newer formats when the data is updated by applications that expect a more recent format than the format in which the data is currently stored.

### BRIEF SUMMARY OF THE INVENTION

In view of the above background it is therefore an object of the present invention to provide for smooth versioning of classes of objects.

It is another objective of the present invention to provide for on-the-fly addition and retraction of class attributes to improve the implementation of methods while providing backwards compatibility with older application clients.

It is another objective of the present invention to provide for on-the-fly addition and retraction of class associations with other classes to add new functionality to existing methods.

It is another object of the invention to provide for on-the-fly addition of polymorphic class operations to add new functionality for new application clients.

It is still another objective of the present invention to avoid upgrading all objects and classes of objects at once.

It is a further objective of the present invention to provide upgraded versions of classes gradually over time without losing any compatibility with existing objects.

It is a further objective of the present invention to store identification links that show the relationship of one class version to another.

It is still another objective of the present invention to transparently allow users to take advantage of new version functionality, even when the user believe they are using a prior version of software.

It is a further objective of the present invention to reduce system downtime due to recompiling of new classes.

It is yet another objective of the present invention to allow older objects to be used by new software.

These and other objectives of the present invention will be come apparent to those skilled in the art from a review of the specification that follows.

The present invention is an architecture for versioning of classes of objects “on the fly,” that is, without recompiling. The system and method of the present invention allows class versioning gradually over time as the system is used by system users.

Using this on the fly versioning, an ISP having a complex network architecture and many application programs can continually upgrade without the potential for entire system downtime.

The present invention accomplishes this by modeling the network and customers of, for example, a large ISP. It should be noted that while the example of an ISP is being used throughout this application, this is not meant as a limitation. Clearly the techniques, methods and architecture of the present invention can be used in any large data processing environment having disparate operating systems and application software.

The ISP operating system, software application programs and any other configurable software (hereinafter “versionable software”) are noted. As part of this modeling process, all service being offered and associations of data are noted. All of the internal properties of the network environment are noted and recorded.

Using this model information as a database, when one class is upgraded to a newer version, information on other pieces of data that are required to work with the new software are maintained. When users use the new software, and that new software calls upon, as necessary, the older object.

### BRIEF DESCRIPTION OF THE DRAWINGS

FIGS. 1A-D illustrate the overall process of a first embodiment of the present invention.

FIG. 2 illustrates top-level and mid-level class additions in accordance with a first embodiment of the present invention.

FIGS. 3 illustrates the consequences of bottom-level class additions in accordance with a first embodiment of the present invention.

FIG. 4 illustrates the consequences of mid-level class changes in accordance with a first embodiment of the present invention.

FIGS. 5A-D illustrate the overall process of a second embodiment of the present invention.

FIG. 6 illustrates top-level and mid-level class additions in accordance with a second embodiment of the present invention.

FIGS. 7 illustrates the consequences of bottom-level class additions in accordance with a second embodiment of the present invention.

FIG. 8 illustrates the consequences of mid-level class changes in accordance with a second embodiment of the present invention.

### DETAILED DESCRIPTION OF THE INVENTION

The class versioning architecture of the present invention provides: on-the-fly addition and retraction of class attributes to improve the implementation of methods while providing backwards compatibility with older application clients; on-the-fly addition and retraction of class associations with other classes to add new functionality to existing methods; and on-the-fly addition of polymorphic class operations to add new functionality for new application clients.

To achieve this functionality, the present invention takes advantage of standard object-oriented programming concepts, including: standard polymorphism, a common object-oriented concept that allows many different kinds of classes to expose the same operations with different implementation methods; rules evaluation, a common concept that allows the owner of the application to invoke operations when one or more attributes take on a particular set of values; and privatization of class attributes, a common object-oriented concept that provides a way to hide the implementation-specific attributes of an implementation method.

The following set of examples demonstrates the consequences of:

1) creating a class,

2) creating a class that inherits from a top-level class,

3) creating a class that inherits from a mid-level class, and

4) changing a mid-level class.

These examples make a distinction between what a user sees as the system model (on the right in the following figures) and what a meta model compiler of the present invention generates for the running system. Every change creates a new version of one or more classes.

Although the present invention is drawn to class versioning, its primary utility is in combination with the present inventors'class transitioning invention, disclosed in co-pending application Attorney Docket No.: 2655-002.

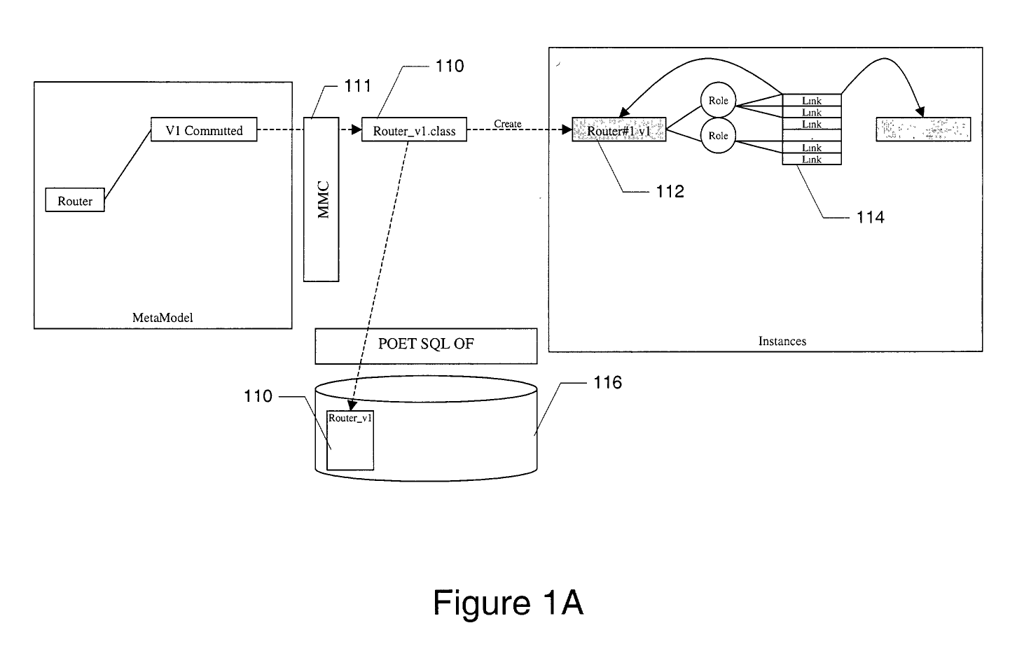

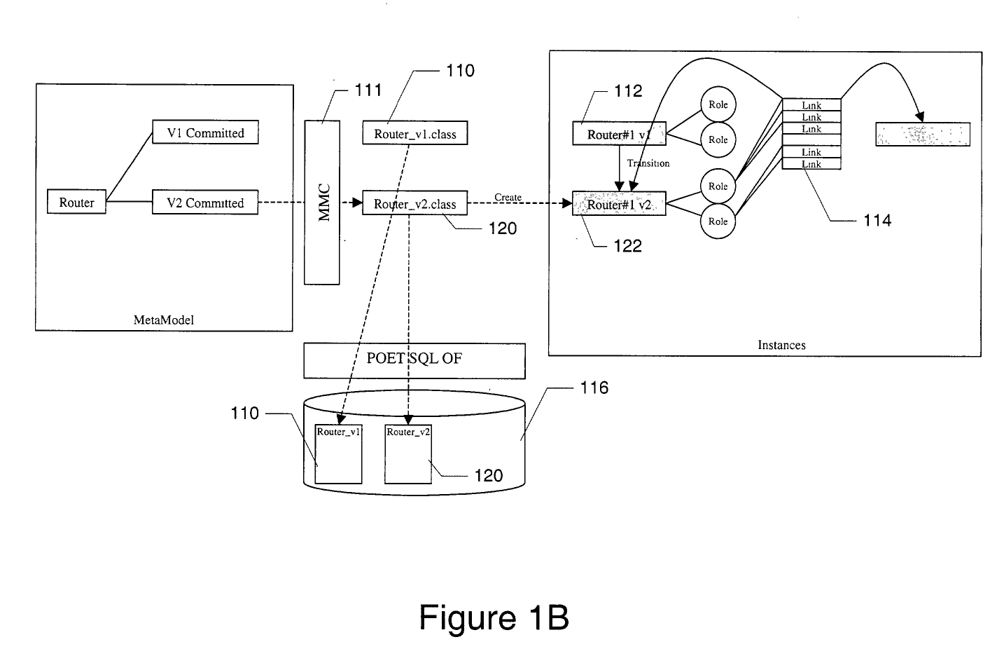

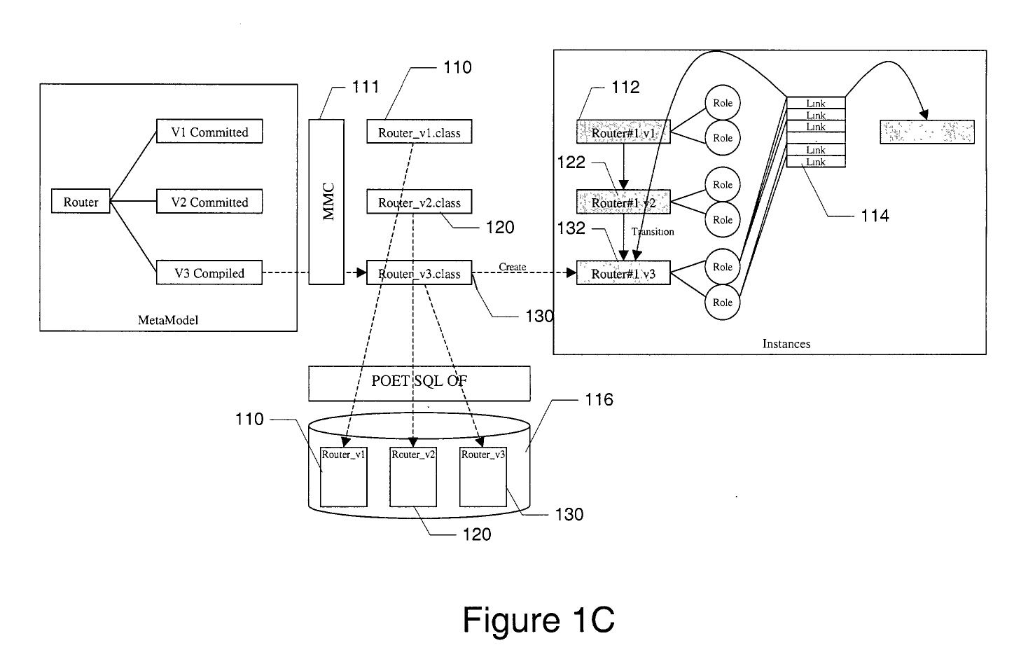

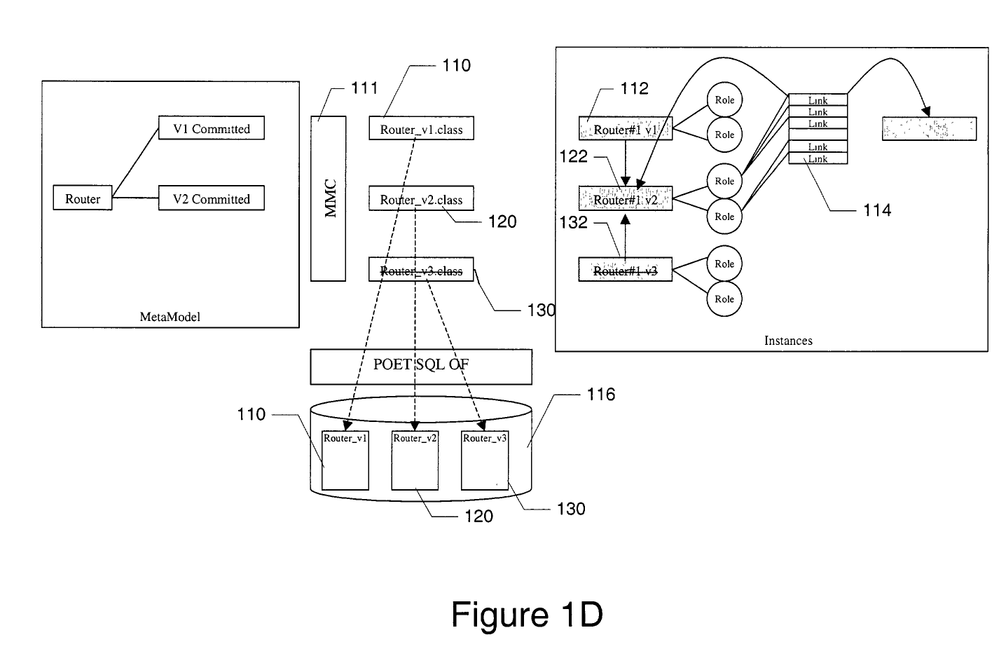

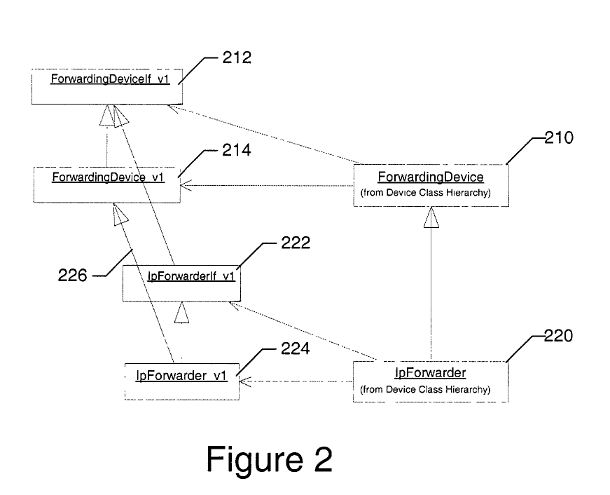

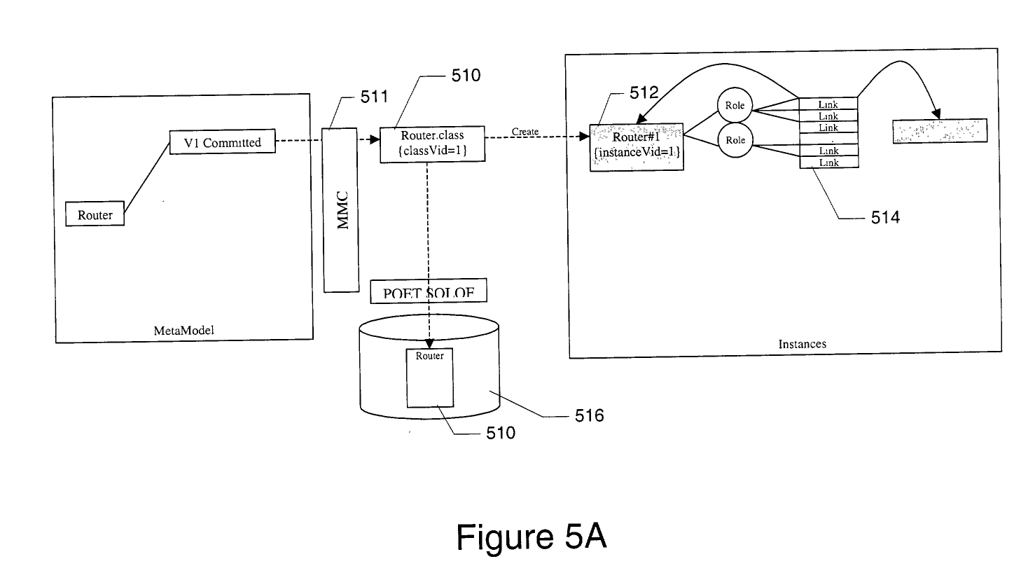

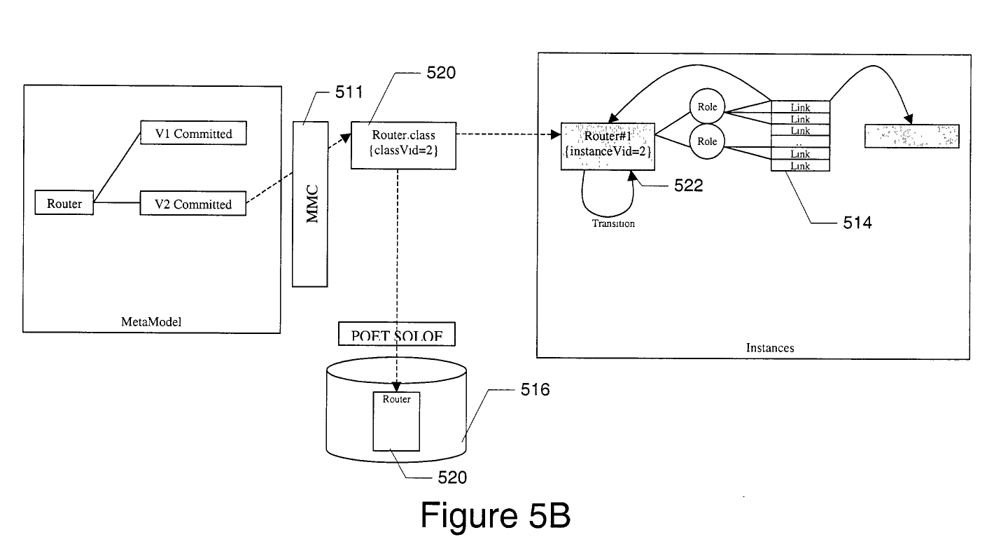

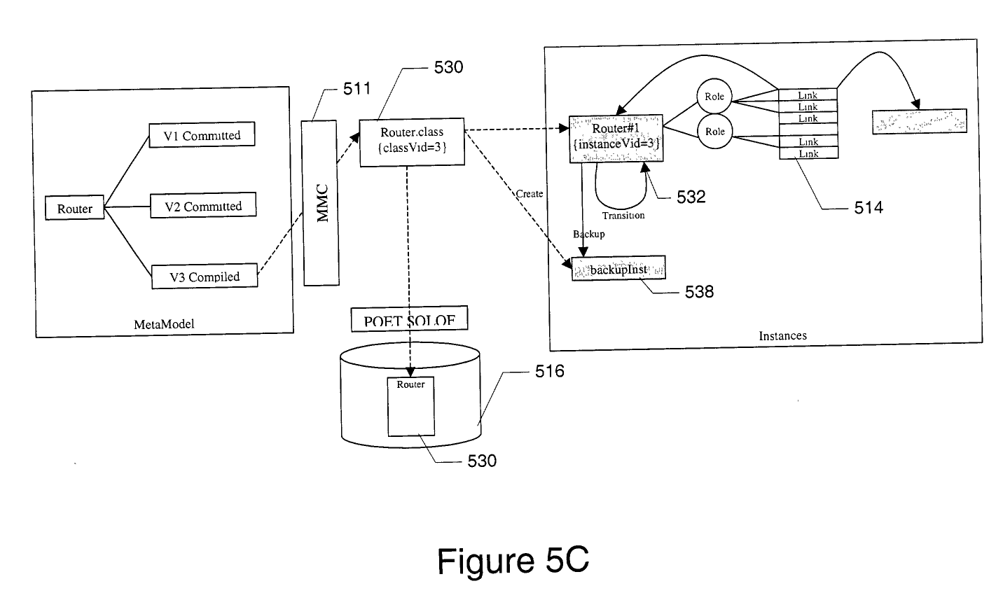

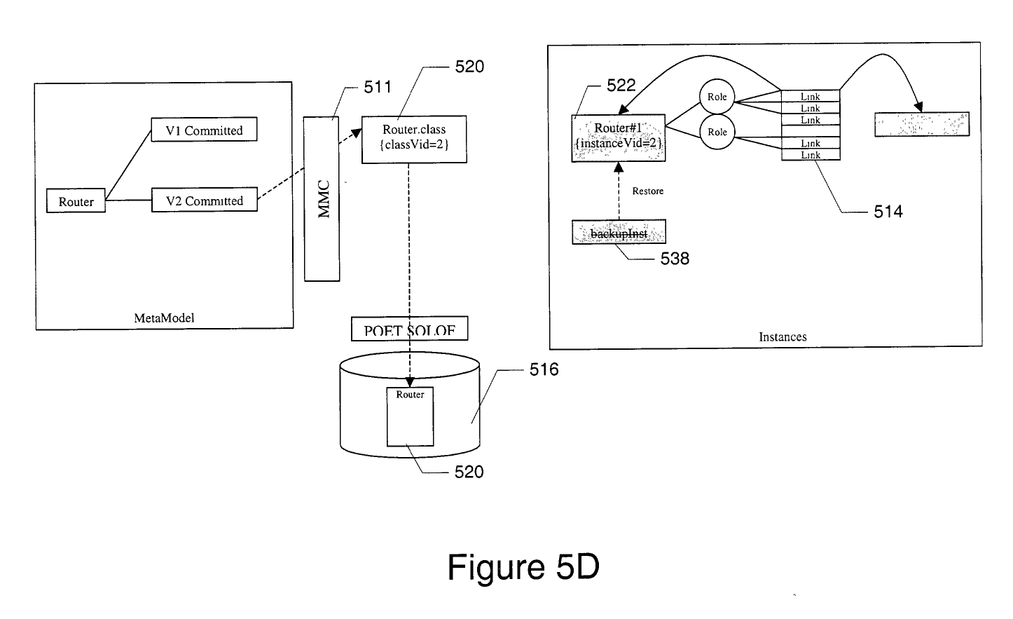

FIGS. 1A-D illustrate an overview of a first embodiment of class the versioning of the present invention in combination with instance transitioning, which is further described in FIGS. 2-4. Although described with respect to a typical scenario, the invention is not meant to be so limited. A similar scenario is shown in FIGS. 5A-D with respect to a second embodiment of the versioning of the present invention and its transitioning scheme and helpful in illustrating the differences between the two embodiments disclosed herein.

FIG. 1A illustrates the first step in which Router v1 110 is created, committed (compiled and approved) by the meta model compiler 111, and deployed. An instance of Router v1 (Router#1) 112 is created and the links 114 to Router#1 v1 are added. In a preferred embodiment, the present invention provides persistent storage 116 using the POET SQL Object Factory or “FastObjects” object oriented database mapping software available from POET Software of San Mateo, Calif.

FIG. 1B illustrates the second step. Here, Router v2 120 is created, committed, and deployed. Router#1 is then transitioned from v1 to v2 122. The third step is illustrated in FIG. 1C, wherein Router v3 130 is created, compiled, and deployed with Router#1 transitioned from v2 to v3 132. The final step is illustrated in FIG. 1D, wherein Router v3 132 is rolled back to Router v2 122. There are advantages and disadvantages associated with this first embodiment of class versioning and the instance transitioning scheme of the present invention. This first embodiment uses an explicit class versioning scheme, which creates a new Java class for each new version of a type. In order to maintain backwards compatibility, a parent class versioning causes all of its subclasses get versioned.

An advantage to this scheme is that class versioning is explicitly controlled by the application. Each class versions are represented by different Java class definitions. Different Java class definitions for different class versions can co-exist in the running system. However, there are also disadvantages. Since instances of those classes need to be persisted, the number of persistence classes in the system can grow exponentially. Also, it makes access to the persisted objects (e.g., via Java Remote Method Invocation (RMI)) difficult since they have to deal with version numbers in interface and class names. And finally, a query on a type has to be explicitly executed on all the versioned classes.

This first embodiment uses the default class hierarchy mapping option (STORE DEFAULT) of the POET SQL OF RSMAP utility. With this default mapping option, each persistence class is mapped into a table in relational database. Each table of a subclass has all the columns inherited from its parent class in addition to its own columns. One row is inserted into the table of the class when an instance is saved into database. In order to support polymorphic query, POET RSMAP utility creates a “polymorphic” view for each parent class table, which ‘unions’ all the subclass tables.

POET SQL Object Factory supports three types (and certain combinations) of class inheritance mapping options: STORE DEFAULT, STORE ALL, and STORE UNIVERSAL. The following examples show the differences among the three options.

Assume that there are three classes—A, B, and C.

| Class | Base Class | Members |
|---|---|---|
| A | None | A1 |
| B | A | (A1), B1 |
| C | B | (A1, B1), C1 |

STORE DEFAULT option on A, B, and C:

| Class | Generated Table (Columns) | Rows in the Table |
|---|---|---|
| A | A (A1) | Instances of Class A |
| B | B (A1, B1) | Instances of Class B |
| C | C (A1, B1, C1) | Instances of Class C |

STORE ALL option on B, and STORE DEFAULT on A and C:

| Class | Generated Table (Columns) | Rows in the Table |
|---|---|---|
| A | A (A1) | Instances of Class A |
| B | B (A1, B1) | Instances of Class B and C |
| C | C (A1, B1, C1) | Instances of Class C |

STORE UNIVERSAL option on B, and STORE DEFAULT
on A and C:

| Class | Generated Table (Columns) | Rows in the Table |
|---|---|---|
| A | A (A1) | Instances of Class A |
| B | B (A1, B1, C1) | Instances of Class B and C |
| C | | |

The STORE DEFAULT mapping option has the advantage that it provides overall well balanced performance for insert, update, delete, and search. A disadvantage of this option is that there is a big view at the level which ‘unions’ all the tables in the system. The SQL statement to create this view can be very large if there are many persistence classes in the system. POET RSMAP utility imposes a limit of 64 k bytes on how large the SQL statement can be handled. If the SQL statement exceeds this limit, the system receives an error from RSMAP utility, and mapping schema is not correctly created or updated. Because of this limitation, this embodiment can only handle, at most, a couple of hundreds of types including versions, which is not acceptable to many customers.

This first embodiment also creates new instances when transitioning old instances. It relies on the “pointers” in those instances to track superseding and preceding instances. This has the advantage that it can create instances of old class versions, and get old behavior of those versions. It also makes “rollback” quite easy. However, since this embodiment keeps old instances in the database, the size of the instance database can grow exponentially. In the same time, since it creates new instances for new class versions, maintaining correct and reliable links among instances can be a very complicated task.

Because this first embodiment relies on explicit class versioning scheme, it needs to run “TypeFilter” to substitute any occurrence of interface or class names in user code. Although this has the advantage of making the class versioning scheme transparent to users, it causes extra overhead in compilation and may introduce potential problems.

FIG. 2 illustrates the consequences of top-level and mid-level class additions. When a user creates the classes ForwardingDevice 210 and IpForwarder 220, the meta model compiler will generate two classes for each user-visible class:

an interface class (ForwardingDeviceIf v1 212), with only the operation signatures, and a class (ForwardingDevice v1 214), with both attributes and implementation methods for those operation signatures.

The reason the meta model compiler creates the interface class is to ensure that existing programs can continue to run with new revisions of a class. The one rule that makes this work is never remove methods. If the service provider makes an operation accessible it cannot retract that operation. If the service provider were to retract an operation it could cause existing programs to misbehave.

In the top-level-class case, the meta model compiler simply generates the ForwardingDeviceIf_v1 interface 212, and generates the ForwardingDevice_v1 class 214 to implement that interface 212.

In the mid-level-class case, the meta model compiler generates the IpForwarderIf_v1 interface 222, and generates the IpForwarder_v1 class 224 to both (1) implement that interface 222 and (2) inherit, via inheritance relationship 226, from the ForwardingDevice_v1 class 214.

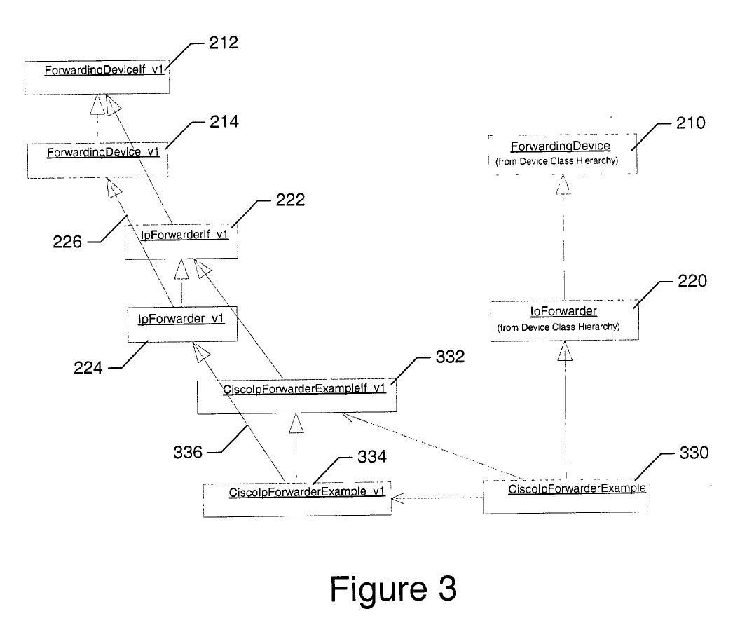

FIG. 3 illustrates the consequences of a bottom-level class addition. As in the previous example of FIG. 2, creating a CiscoIpForwarderExample class 330 creates an interface 332 and a class 334 that implements it. It also creates the inheritance relationship 336 with IpForwarder class 224.

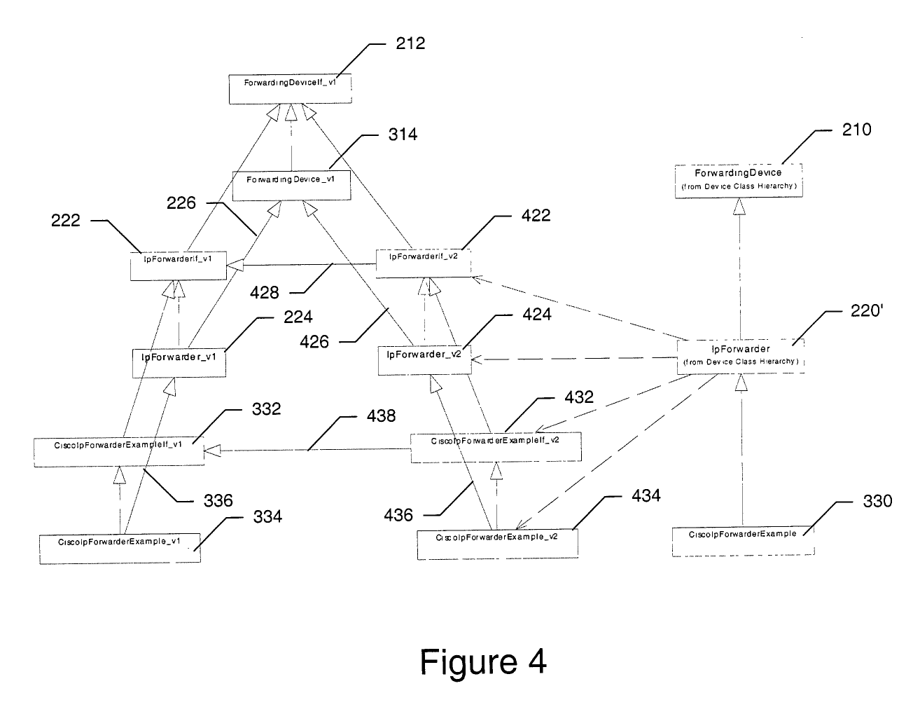

FIG. 4 illustrates the consequences of a class change. In this example, when someone changes the IpForwarder class 220′ (and hence changes IpForwarderIf_v1 interface 222 and IpForwarder_v1 class 224 to generate IpForwarderIf_v2 interface 422, IpForwarder_v2 class 424 and inheritance relationships 426, 428), it causes changes below it. The meta model compiler must create new versions of all of the child classes that inherit from a changed parent class so the children pick up the changes to the parent. The meta model compiler recurses down the tree until all the child classes (i.e., CiscoIpForwarderExample class 330) have new versions. In addition, the meta model compiler must make the new version of each interface class inherit the interface of the previous version. As the meta model compiler recurses down the tree, it ensures that all the child interfaces, CiscoIpForwarderExampleIf interface 332 have new versions (i.e., v2) 432 that inherit 438 from the old version (i.e., v1) 332. Note that the second and subsequent versions of an interface inherit from both the interface above them in the tree and the previous version of the interface. Sometimes inheriting from the interface above is redundant, but doing so reduces code complexity.

A second, and preferred embodiment of the class versioning of the present invention and instance transitioning is shown in FIGS. 5A-D. This second scheme also shows a typical scenario, which is not meant to cover all the cases of the present invention.

FIG. 5A illustrates the first step in which Router v1 510 is created, committed, and deployed. An instance Router#1 512 is created and the links 514 to Router#1 are added. Note that in this embodiment, the class name generated by the meta model compiler 511 does not contain any version information and that the generated class contains a static attribute of the class version. The instance contains an instance Vid, of which it is created. In a preferred embodiment, the present invention again uses a persistent storage database 516 with the POET SQL Object Factory or “FastObjects” object oriented database mapping software available from POET Software of San Mateo, Calif.

FIG. 5B illustrates the second step. Here, Router v2 520 is created, committed by meta model compiler 511, and deployed. Router#1 is then transitioned 522. Before transitioning, versionId in Router#1 is “1”. After transitioning, it is set to “2”. When transitioning to a committed type, no new instance is created. When transitioning an instance, no link 514 is transitioned.

The third step is illustrated in FIG. 5C, wherein Router v3 530 is created, compiled, and deployed. Router#1 is transitioned 532. When transitioning to a compiled type, a backup instance 538 is created to save the previous attribute values. After transitioning, versionId of Router#1 is set to “3”, which is the latest version of that class.

The final step is illustrated in FIG. 5D, wherein Router v3 is rolled back (to Router v2 522). When rolling back Router v3, Router#1 is restored from the backup instance 538. Its versionId is set back to “2”. After rollback, the backup instance 538 is removed and the v2 Router class is available to the running system. If links 514 are modified by the user after transition to a COMPILED (as opposed to commited) type, the original set of links can not be rolled back.

This second embodiment of FIGS. 5A-D differs from the first embodiment disclosed in FIG. 1A-1D in the following four aspects:

First, it uses implicit class versioning, which does not create new persistence Java class for each new version. Instead, it keeps the same Java class name. It maintains static information of latest version of the class, and maintains an internal versionId in each instance.

Second, it uses alternate class hierarchy mapping options provided by POET RSMAP utility to significantly reduce the size of “polymorphic” views so that the system can support far more types. The system will apply STORE ALL option (hard-coded) to all the direct subclasses. Therefore, the following “polymorphic” views will be created:

At a privileged resource root level, a “polymorphic” view includes all the direct subclasses. Since the system does not allow user to subtype directly, the size of this view should not grow out of control.

Since STORE ALL option is applied to all direct subclasses of the privileged resource root level, no “polymorphic” view is created for those classes

“Polymorphic” views will be created for each non-leaf class. Potentially, when the individual class hierarchies grow too big (deep or/and wide), the system may run into the same problem as the one found in the first embodiment. If that is the case, the system can apply additional STORE ALL or STORE UNIVERSAL mapping option at a lower level of a particular inheritance hierarchy.

Third, the system uses POET class versioning and instance transitioning capability (RSMAP-v) to provide the backend storage changes. However, POET class versioning and instance transitioning is too simple. It only adds columns in relational database tables to reflect changes of class attributes (add, delete, or rename). The system still needs to apply its own instance transitioning capability on the top of POET so that customers can introduce more complicated transitioning logic. The system transitions instances based on the internal versionId, and the latest version of that class. As such, the system needs to maintain the same readLock( ) and writeLock( ) semantics in the first embodiment.

And finally, since the system uses implicit class versioning, it does not need to run “TypeFilter” any more.

The advantages of this preferred second embodiment of the versioning and transitioning scheme are: (i) uses simpler and less code, therefore it should be more reliable and introduce fewer bugs; (ii) creates much fewer classes and instances in the system so that it improves overall performance; (iii) provides better runtime performance since it does not need to always follow “pointers” to get the latest version of the instance; (iv) supports “unlimited” number of versions of each type; and (v) simplifies other applications, which interface with the system, such as RMI client.

Certain assumptions are associated with this embodiment. It transitions instances whenever it touches them. Since it transitions instances whenever it touches them, applications should always commit the transaction. Rollback should only be called when error occurs. Applications should only hold short transactions. In case of large result sets in a query, the present invention preferably implements a mechanism to allow users to iterate through the query over multiple short transactions. The system needs to backup transitioned instances to support “rollback” for non-committed types only to simplify testing. However, in the production system, it does not need to support instance backup and rollback since the user should not deploy a non-committed type. The user is no longer able to create instances of old versions of a type.

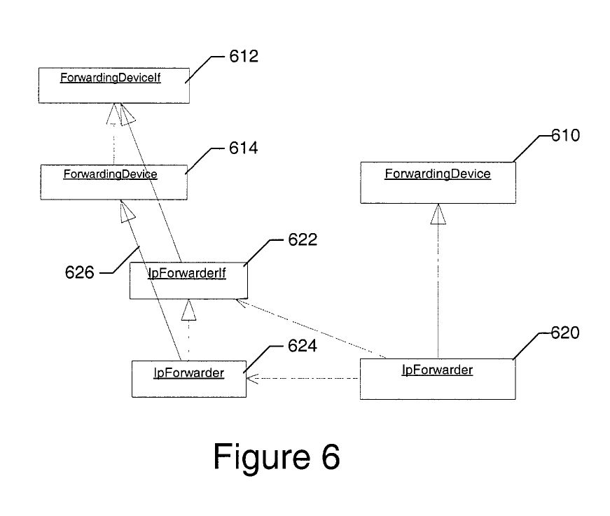

FIG. 6 illustrates the consequences of top-level and mid-level class additions in the second embodiment of the present invention. When a user creates the classes ForwardingDevice 610 and IpForwarder 620, the meta model compiler will generate two classes for each user-visible class:

an interface class (ForwardingDeviceIf 612), with only the operation signatures, and

a class (ForwardingDevice 614), with both attributes and implementation methods for those operation signatures.

Again, the reason the meta model compiler creates the interface class is to ensure that existing programs can continue to run with new revisions of a class. The one rule that makes this work is never remove methods. If the service provider makes an operation accessible it cannot retract that operation. If the service provider were to retract an operation it could cause existing programs to misbehave.

In the top-level-class case, the meta model compiler simply generates the ForwardingDeviceIf interface 612, and generates the ForwardingDevice class 614 to implement that interface 612.

In the mid-level-class case, the meta model compiler generates the IpForwarderIf interface 622, and generates the IpForwarder class 624 to both (1) implement that interface 622 and (2) inherit, via inheritance relationship 626, from the ForwardingDevice class 614.

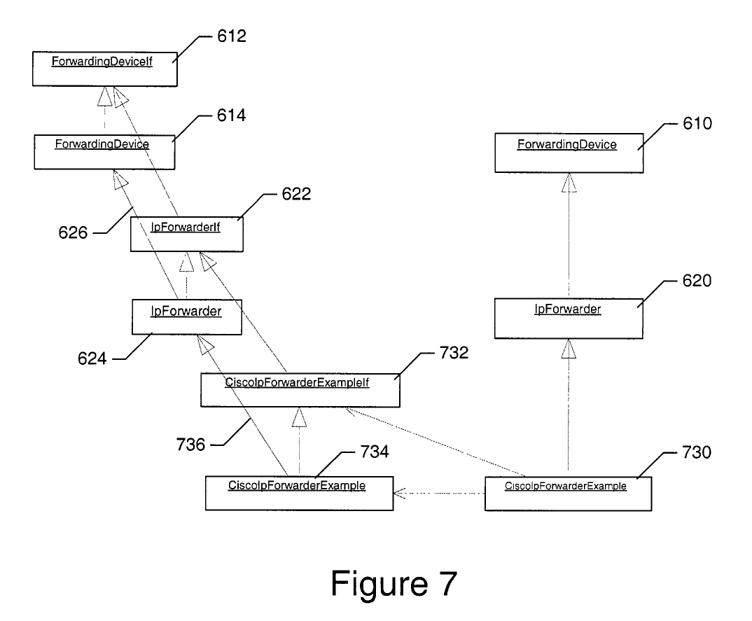

FIG. 7 illustrates the consequences of a bottom-level class addition in the second embodiment of the present invention. As in the previous example of FIG. 6, creating a CiscoIpForwarderExample class 730 creates an interface 732 and a class 734 that implements it. It also creates the inheritance relationship 736 with IpForwarder class 624.

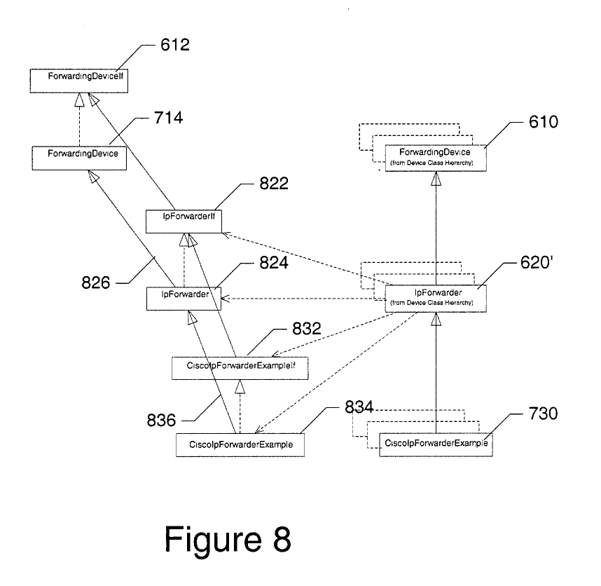

FIG. 8 illustrates the consequences of a class change in the second embodiment of the present invention. In this example, when someone changes the IpForwarder class 620′ (and hence changes IpForwarderIf interface 622 and IpForwarder class 624, it causes changes below it. The meta model compiler must create new versions of all of the child classes that inherit from a changed parent class so the children pick up the changes to the parent. The meta model compiler recurses down the tree until all the child classes (i.e., CiscoIpForwarderExample class 730) have new versions. In addition, the meta model compiler must make the new version of each interface class inherit the interface of the previous version. As the meta model compiler recurses down the tree, it ensures that all the child interfaces, CiscoIpForwarderExampleIf interface 732 have new versions 832 that inherit 838 from the old version 732. Note that the second and subsequent versions of an interface inherit from both the interface above them in the tree and the previous version of the interface. Sometimes inheriting from the interface above is redundant, but doing so reduces code complexity.

Using either embodiment of the present invention, an organization can obtain a unified view of customers, services and networks, understand the relationships among key business data, represent complex IP services, obtain a pre-built core model of networks, services and rules for easy customization, access integrated data at multiple levels of abstractions to solve a variety of business problems, allow easy adaptation to business dynamics and obtain superior data integrity at substantial cost savings over existing systems.

Although described herein with reference to an ISP, the present invention is not so limited and has utility to other applications, including, but not limited to, health care, hotel-motel management, genome mapping, military and homeland security applications.

It will be understood by those skilled in the art that these advantages and functions are not meant as limiting but are examples of the functions and advantages of the present invention.

We claim:

1. A method for providing on-the-fly class versioning of at least one object class in an object-oriented environment, comprising:
creating a first version of an object class;
compiling said first version of said object class
deploying said first version of said object class in said object-oriented environment;
creating at least a second version of said object class;
compiling said second version of said object class;
deploying said second version of said object class in said object-oriented environment on-the-fly;
always creating instances of said object based on a most recent version of said object class; and
providing for rolling back a version of said object class from the most recent version to a prior version on-the-fly,
wherein said at least second version of said object class inherits all attributes, associations and operations from said first version of said object, and wherein said first and second versions of said object class are deployed by mapping each class into a persistence storage means.

2. The method of claim 1, further comprising:
creating at least one subsequent version of said object class;
compiling said at least one subsequent version of said object class; and
deploying said at least one subsequent version of said object class in said object-oriented environment on-the-fly;
wherein said at least one subsequent version of said object class inherits all attributes, associations and operations from prior versions of said object, and wherein all versions of said object class are deployed by mapping each class into a persistence storage means.

3. The method of claim 2, further comprising providing said rolling back by retrieving a most-recent prior version from the persistence storage means, re-compiling and re-deploying said prior version on-the-fly.

4. The method of claim 2, further comprising providing on-the-fly class versioning to a plurality of object classes.

5. The method of claim 2, further comprising explicit versioning by creating a new class for each new version in a manner such that versioning of a parent class causes all its subclasses to be versioned.

6. The method of claim 4, wherein a persistent storage representation of a subclass version inherits all persisted data storage of its parent class in addition to its own persistent data.

7. The method of claim 6, further comprising creating a polymorphic view for each parent class table that is a union of all its version tables.

8. The method of claim 2, further comprising creating, compiling and deploying two classes for each user-created class, said two classes comprising:
an interface class with only operation signatures to ensure existing programs can continue to run with new versions of the user-created class; and
a method class with both attributes and implementation methods for the operation signatures, wherein methods are never removed.

9. The method of claim 8, further comprising said interface class inheriting from both prior interface classes and any subsequent interface classes.

10. The method of claim 2, further comprising implicit versioning by maintaining static information on a latest version of the class by adding a non-persisted attribute to the class in a manner such that versioning of a parent class causes all its subclasses to be versioned.

11. The method of claim 10, wherein each persistent storage representation of a subclass version inherits all persisted data storage of its parent class in addition to its own persistent data.

12. The method of claim 11, further comprising creating a polymorphic view for each parent class table that is a union of all its version tables.

13. The method of claim 10, further comprising creating, compiling and deploying two classes for each user-created class, said two classes comprising:
an interface class with only operation signatures to ensure existing programs can continue to run with new versions of the user-created class; and
a method class with both attributes and implementation methods for the operation signatures, wherein methods are never removed.

14. The method of claim 13, further comprising said interface class inheriting from both prior interface classes and any subsequent interface classes.

15. The method of claim 1, further comprising providing said persistent storage means using a relational database.

16. A apparatus for providing on-the-fly class versioning of at least one object class in an object-oriented environment, comprising:
a server computer having a processor, an operating system, random access memory and persistent storage means;
software instructions adapted to create a first version of an object class;
software instructions adapted to compile said first version of said object class
software instructions adapted to deploy said first version of said object class in said object-oriented environment;
software instructions adapted to create at least a second version of said object class;
software instructions adapted to compile said second version of said object class;
software instructions adapted to deploy said second version of said object class in said object-oriented environment on-the-fly;
wherein said software instructions always create instances of said object based on a most recent version of said object class; and
software instructions adapted to provide for rolling back a version of said object class from the most recent version to a prior version on-the-fly,
wherein said at least second version of said object class inherits all attributes, associations and operations from said first version of said object, and wherein said first and second versions of said object class are deployed by mapping each class into said persistence storage means.

17. The apparatus of claim 16, further comprising:
software instructions adapted to create at least one subsequent version of said object class;
software instructions adapted to compile said at least one subsequent version of said object class; and
software instructions adapted to deploy said at least one subsequent version of said object class in said object-oriented programming environment on-the-fly;
wherein said at least one subsequent version of said object class inherits all attributes, associations and operations from prior versions of said object, and wherein all versions of said object class are deployed by mapping each class into said persistence storage means.

18. The apparatus of claim 17, further comprising software instructions adapted to provide said rolling back by retrieving a most-recent prior version from the persistence storage means, re-compiling and re-deploying said prior version on-the-fly.

19. The apparatus of claim 17, further comprising software instructions adapted to provide on-the-fly class versioning to a plurality of object classes.

20. The apparatus of claim 17, further comprising explicit versioning by software instructions adapted to create a new class for each new version in a manner such that versioning of a parent class causes all its subclasses to be versioned.

21. The apparatus of claim 19, wherein a persistent storage representation of a subclass version inherits all persisted data storage of its parent class in addition to its own persistent data.

22. The apparatus of claim 21, further comprising software instructions adapted to create a polymorphic view for each parent class table that is a union of all its version tables.

23. The apparatus of claim 17, further comprising software instructions adapted to create, compile and deploy two classes for each user-created class, said two classes comprising:
an interface class with only operation signatures to ensure existing programs can continue to run with new versions of the user-created class; and
a method class with both attributes and implementation methods for the operation signatures, wherein methods are never removed.

24. The apparatus of claim 23, further comprising said interface class having inherited from both prior interface classes and any subsequent interface classes.

25. The apparatus of claim 17, further comprising implicit versioning by software instructions adapted to maintain static information on a latest version of the class by adding a non-persisted attribute to the class in a manner such that versioning of a parent class causes all its subclasses to be versioned.

26. The apparatus of claim 25, wherein each persistent storage representation of a subclass version has inherited all persisted data storage of its parent class in addition to its own persistent data.

27. The apparatus of claim 26, further comprising software instructions adapted to create a polymorphic view for each parent class table that is a union of all its version tables.

28. The apparatus of claim 25, further comprising software instructions adapted to create, compile and deploy two classes for each user-created class, said two classes comprising:
an interface class with only operation signatures to ensure existing programs can continue to run with new versions of the user-created class; and
a method class with both attributes and implementation methods for the operation signatures, wherein methods are never removed.

29. The apparatus of claim 28, further comprising said interface class having inherited from both prior interface classes and any subsequent interface classes.

30. The apparatus of claim 16, wherein said persistent storage means is a relational database.

31. The apparatus of claim 16, further comprising a network interface means.
